(19) United States
(12) Patent Application Publication
(10) Pub. No.: US 2003/0215612 A1
(43) Pub. Date: Nov. 20, 2003

(54) Thin-sheet insulation material and its use

(76) Inventor: Chester L. Richards JR., Thousand Oaks, CA (US)

Correspondence Address: PATENT DOCKET ADMINISTRATION, RAYTHEON SYSTEMS COMPANY, P.O. BOX 902 (E1/E150), BLDG E1 M S E150, EL SEGUNDO, CA, 90245-0902, US

(21) Appl. No.: 10/150,981

(22) Filed: May 17, 2002

(51) Int. Cl. B32B 3/00

(52) U.S. Cl. 428/174

(57) ABSTRACT

An insulation material includes a first sheet having a thickness of from about 0.002 inch to about 0.010 inch. The first sheet includes a polymer layer made of a polymer material, and a metallization layer made of a metallic material overlying and contacting the polymer layer. A large number of dimples are formed in the first sheet and extend above the first sheet. Two or more of the sheets are stacked in facing relationship, spaced apart by the dimples. Joints may be made by overlapping adjacent sheets. Complex, nonplanar objects may be insulated by providing nonplanar transition sheets between adjacent sheets, and overlapping the transition sheets and the insulation sheets.

### BACKGROUND OF THE INVENTION

This invention relates to thin-sheet insulation materials and, more particularly, to a form of such insulation materials that facilitates the fabrication of insulated structures and achieves improved insulation performance.

Insulation in the form of thin sheets is widely used, particularly for low-temperature applications. For example, a structure which is to be operated at liquid nitrogen temperature (77° K at 1 atmosphere pressure) is insulated to achieve uniformity in temperature and to reduce consumption of coolant. A well-known insulation material for use in flight-vehicle applications, where weight is a consideration, is a multi-layer insulation formed by collating a number of individual thin sheets. Each thin sheet is formed as a layer of an organic material such as a polyimide about 0.00025 inch thick, with a very thin layer of a metal such as aluminum deposited on the organic layer to serve as a heat reflector. In the assembled multi-layer stack of sheets, the metallization of the individual sheets inhibits radiative heat transfer through the stack. There is a space between each sheet and the adjacent sheet, resulting in relatively low conductive heat transfer as well. Desirably, there are as few points of contact between the adjacent sheets as possible, to minimize direct conduction of heat through the sheets.

The multi-layer insulation approach functions well, is light in weight, and is widely used. However, it has some shortcomings. The installation of many sheets, each of which is very thin and therefore difficult to handle manually, is extraordinarily time consuming and requires a high degree of skill in the installation workers. Because the installation requires such worker skill, there may be a substantial variation in performance among insulations installed by different people, or by the same person at different times, even though standard procedures are followed. It is difficult to obtain uniform insulation of simple shapes, but insulation of complex shapes is even more challenging because of the difficulty in forming the thin sheets around the complex shape in a controlled manner.

Additionally, when multiple sheets are collated, there is a tendency for them to compress together, resulting in higher conductive heat transfer through the sheets than is desirable. Low-conductivity spacers positioned between the sheets and intentional crinkling of the sheets to prevent excessive contact during compression have been used to reduce the effects of inter-sheet compression, making the installation even more difficult. With such arrangements, there is still higher thermal conductivity through the collated stack of sheets than is desirable.

There is a need for an approach that utilizes the basic approach of multiple sheets collated to form an insulation, but which overcomes the shortcomings of installation difficulty for simple and complex shapes, and reduced performance as a result of the installation approach. The present invention fulfills this need, and further provides related advantages.

### SUMMARY OF THE INVENTION

The present invention provides an insulation material and a method for its use in insulating structures. The insulation utilizes the advantageous properties of thin-sheet insulation, but improves upon the existing material by eliminating its shortcomings. The new insulation material accomplishes low thermal conduction and radiative heat transfer with a structure of the sheets that achieves carefully controlled contacts between adjacent sheets in a multi-layer insulation. Collation of the individual sheets to form the multi-layer stack is greatly simplified, and becomes largely a “drop-in” procedure rather than a careful sheet-by-sheet stacking. The fabrication of insulation around complex shapes is also simplified. The fabrication of insulation around both simple and complex shapes is made easier and less expensive, and the insulation properties are better and more uniform, as compared with prior approaches.

In accordance with the invention, an insulation material comprises a first sheet including a first polymer layer made of a first polymer material, and a first metallization layer made of a first metallic material overlying and contacting the first polymer layer. There is a selected pattern of a first plurality of first dimples formed in the first sheet and extending above (i.e., outwardly from) the first sheet.

The first sheet preferably has a thickness of not less than about 0.002 inch, more preferably from about 0.002 inch to about 0.010 inch, substantially thicker than conventional thin sheet insulation material. The first polymer material is preferably a polyimide such as Kapton™ polymer or a polyester such as Mylar™ polymer, although other operable solid polymers may be used. The first metallic material is preferably aluminum. The dimples preferably extend above (i.e., outwardly from) the centerline of the sheet by an amount of from about 0.020 inch to about 0.080 inch. The dimples are preferably substantially hemispherical in shape, because this form presents a well-defined geometry and may be readily produced and because such hemispherical bubbles have well-defined heat transfer characteristics which are independent of the spherical radius.

In a collated form, the insulation material further includes a second sheet comprising a second polymer layer made of a second polymer material, and a second metallization layer made of a metallic material overlying and contacting the second polymer layer. There is a second selected pattern of a second plurality of second dimples formed in the second sheet and extending above (i.e., outwardly from) the second sheet. The second sheet is positioned adjacent to and facing the first sheet such that the second sheet is spaced apart from the first sheet by the first dimples. The second sheet may have similar structure to the first sheet, and may in fact be identical in structure to the first sheet.

This insulation formed of multiple dimpled sheets has a well-defined geometry. The metallization functions to inhibit radiative transfer. The dimples space the sheets apart so that they do not contact each other in an uncontrolled pattern to create thermal short circuits. Instead, the selected pattern of dimples defines precise regions of contact between the sheets that are optimized for the best thermal performance. The individual sheets are desirably made thicker than is the conventional practice for multi-layer thermal insulation, so that they have sufficient structural rigidity to resist unintended sagging and thence unintended contacting between adjacent sheets at locations between the dimples. The dimples are sufficiently tall to prevent such unintended contacts. The thicker and more rigid is the sheet material, the shorter may be the dimples.

The formation of joints in the thermal insulation is facilitated by the present approach. Further in accordance with this aspect of the invention, the first sheet is provided as a first piece of the first sheet and a second piece of the first sheet, and the second sheet is provided as a first piece of the second sheet and a second piece of the second sheet. The insulation material comprises a joint whereat the first piece of the first sheet and the second piece of the first sheet overlap each other in a first sheet overlap, and whereat the first piece of the second sheet and the second piece of the second sheet overlap each other in a second sheet overlap. The sheet overlaps greatly reduce preferential radiant heat leakage through the joint. Desirably, only one of the first piece of the first sheet and the second piece of the first sheet has dimples in the first sheet overlap, and only one of the first piece of the second sheet and the second piece of the second sheet has dimples in the second sheet overlap. This approach prevents bulges of material at the joint.

The combination of the use of the dimpled sheet structure and the increased thickness of the sheets in the preferred embodiment allows the multi-layer insulation to be conformed to complexly shaped objects that are to be insulated. Further in accordance with this aspect of the invention, the first sheet is provided as a first piece of the first sheet and a second piece of the first sheet, and the second sheet is provided as a first piece of the second sheet and a second piece of the second sheet. There are also provided a first undimpled transition sheet and a second undimpled transition sheet, which are preferably insulation of the type of the first sheet and the second sheet but without dimples. The insulation material comprises a joint whereat the first piece of the first sheet overlaps a first end of the first undimpled transition sheet and the second piece of the first sheet overlaps a second end of the first undimpled transition sheet, and whereat the first piece of the second sheet overlaps a first end of the second undimpled transition sheet and the second piece of the second sheet overlaps a second end of the second undimpled transition sheet. The transition sheets, which may be planar or nonplanar, allow nonplanar joints to be formed that conform the collated insulation material to complex shapes through the selection of the shape of the transition sheets and the first and second sheets. The insulation of complex shapes is accomplished by selecting the shapes of the various sheets, and then dropping the appropriate sheets into place.

The present approach thus provides an insulation material that is highly efficient and also readily assembled into insulation structures. Other features and advantages of the present invention will be apparent from the following more detailed description of the preferred embodiment, taken in conjunction with the accompanying drawings, which illustrate, by way of example, the principles of the invention. The scope of the invention is not, however, limited to this preferred embodiment.

### BRIEF DESCRIPTION OF THE DRAWINGS

FIG. 1 is a schematic sectional view through a sheet of insulation material;

FIG. 2 is a schematic sectional view through two collated sheets of insulation material;

FIG. 3 is a schematic sectional view through a two collated sheets of insulation material, where one sheet has a hemispherical dimple;

FIG. 4 is a schematic sectional view through four collated sheets of insulation material;

FIG. 5 is a schematic sectional view at a joint in the insulation material;

FIG. 6 is an enlarged view of the joint of FIG. 5, taken in region 6 thereon;

FIG. 7 is a schematic sectional view of multi-layer insulation applied on the inside and outside of a complex shape; and

FIG. 8 is a schematic sectional view of multi-layer insulation applied on the external surface of a cylinder.

### DETAILED DESCRIPTION OF THE INVENTION

FIG. 1 depicts an insulation material 20a comprising a first sheet 22 of insulation. The first sheet 22 includes a first polymer layer 24 made of a first polymer material, and a first metallization layer 26 made of a first metallic material overlying and contacting the first polymer layer 24. The first sheet 22 preferably has a thickness of not less than about 0.002 inch, and more preferably from about 0.002 inch to about 0.010 inch, although the thickness is not so limited. If the thickness of the first sheet 22 is less than about 0.002 inch, it is operable as insulation but its structural rigidity tends to be too low to avoid sagging and sheet-to-sheet contacts in the multi-layer insulation structures discussed subsequently. If the thickness of the first sheet 22 is greater than about 0.010 inch, its weight is increased excessively without added benefit and it may be difficult to form the subsequently discussed dimples. However, there may be instances where the thickness is made greater than about 0.010 inch, in order to provide increased structural rigidity for the sheets to prevent sagging. The first polymer layer 24 is made of any operable film-forming polymer. The first polymer layer 24 is preferably made of a polyimide such as Kapton™ polymer or a polyester such as Mylar™ polymer (polyethylene terepthalate polyester). The first metallization layer 26 is preferably aluminum (either pure or an alloy), deposited on the first polymer layer 24 by a technique such as vapor deposition. The first metallization layer 26 is preferably a few thousand Angstroms thick, so that nearly all of the thickness of the first sheet 22 is the first polymer layer 24. The first sheet 22 inhibits thermal flow by itself being of low thermal conductivity and also by reflecting heat from the metallization layer 26.

There is a first selected pattern of a first plurality of first dimples 28 formed in the first sheet 22 to extend above the first sheet 22 on one side thereof. Only one of the first dimples 28 is illustrated in FIG. 1, but typically there are many more in the first sheet 22, arranged into the first selected pattern that serves the spacer and standoff functions to be discussed subsequently. For example, the first dimples 28 may be arranged in a square, rectangular, hexagonal, or other regular pattern. Each first dimple 28 is formed by locally deforming the sheet 22 into the shape of the first dimple 28 by any operable technique such as a punch, gas pressure on one side of the first sheet when it is heated slightly and supported on the other side by a screen, and the like. The wall thickness of each first dimple 28 is less than that of the general thickness of the first sheet 22, due to the technique by which the first dimples 28 are formed. The layers 24 and 26 are present in the first dimple 28, so that the first dimple 28 serves as a thermal conduction barrier in the same manner as the portion of the first sheet 22 which has no dimple. The first dimples 28 are preferably of about the same height, although some variation is acceptable. The height H of each first dimple 28 is preferably from about 0.020 inch to about 0.080 inch, most preferably about 0.040 inches, measured between the centerlines of the regions of the first sheet 22. (The figures herein are not drawn to scale.) The first dimples 28 are preferably spaced apart from each other in the plane of the first sheet 22 by from about ¼ inch to about 4 inches, most preferably about 2 inches. Thus, the dimples are relatively widely spaced as compared with their heights, and the sheets desirably do not sag and contact each other in the regions between the dimples.

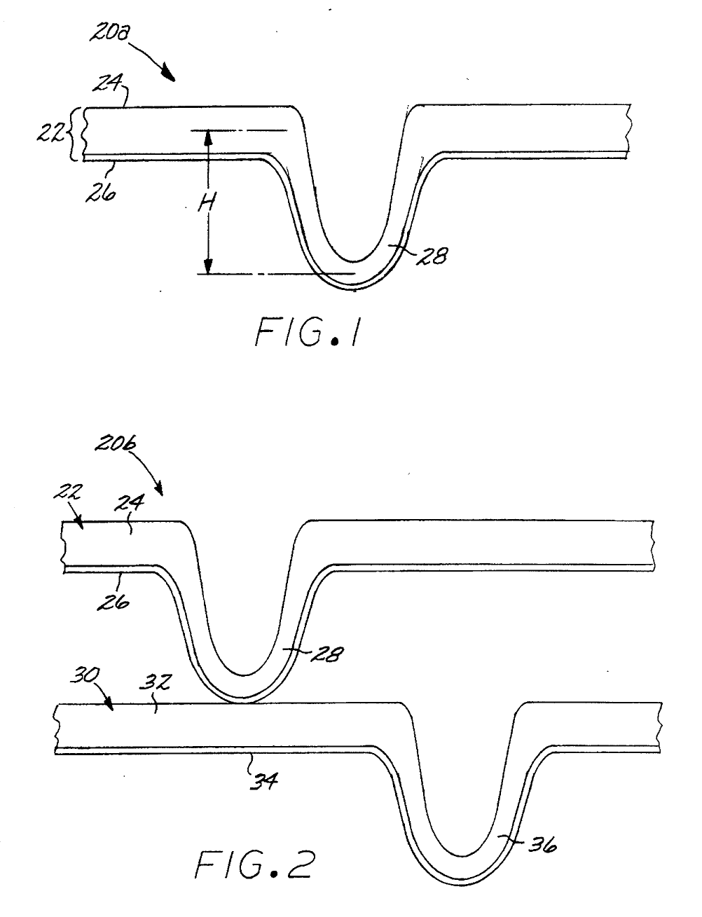

FIG. 2 illustrates an insulation material 20b wherein the first sheet 22 is collated (i.e., stacked in a proper sequence) with a second sheet 30 so that the second sheet 30 lies parallel to the first sheet 22. The second sheet 30 includes a second polymer layer 32 made of a second polymer material, and a second metallization layer 34 made of a second metallic material overlying and contacting the second polymer layer 32. The second sheet 30 may have a second selected pattern formed of a plurality of second dimples 36, extending in the same direction as the first dimples 28. In the illustration of FIG. 2, the second sheet 30 has such second dimples 36. In other embodiments discussed subsequently, the second sheet 30 has no second dimples 36. The second sheet 30 has a structure similar or identical to that of the first sheet 22, and the prior discussion, including the dimensions, materials, characteristics, and fabrication, of the first sheet 22 is incorporated here as to the corresponding aspects of the second sheet 30.

In the insulation 20b of FIG. 2, the second sheet 30 is positioned adjacent to and facing the first sheet 22. The first dimples 28 of the first sheet 22 contact the flat surface of the second sheet 30 on the side of the second sheet 30 opposite to that having the second dimples 36, so that the second sheet 30 is spaced apart from the first sheet 22 by the height of the first dimples 28. The dimples thus contact the adjacent sheet and serve as a spacer and standoff between the two sheets 22 and 30. The thickness of the respective polymer layers 24 and 32 is made sufficiently great that the sheets 22 and 30 do not sag by an amount that brings them into contact in the regions between the dimples. Such contacts would increase the conductive thermal transfer between the sheets 22 and 30.

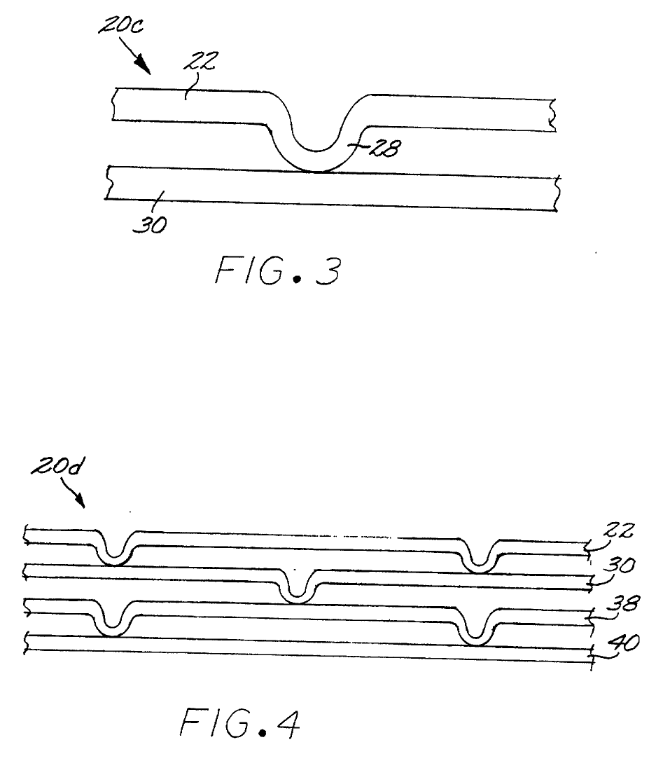

The first dimples 28 and the second dimples 36 may have any operable shape. A particularly useful and readily formed dimple shape is substantially a hemisphere, illustrated for an insulation material 20c in FIG. 3. The hemispherical shape for the dimples has a high rigidity and relatively small contact area with the adjacent sheet, minimizing the thermal conduction between adjacent sheets through the contact areas of the dimples. The hemispherical shape also is exceptionally well suited to act as a low-heat-conduction separation (i.e., spacer or standoff) device. The substantially hemispherical dimples have a well-defined geometry and may be readily produced, and have a well-defined heat transfer characteristics which are independent of the spherical radius. A “hemispherical” shape as used herein includes any segment of a sphere less than the entire sphere, and is preferably one-half of a sphere.

The principles discussed above may be extended to larger numbers of sheets. FIG. 4 illustrates insulation 20d having a collated stack of four sheets 22, 30, 38, and 40. The sheets 22, 30, and 38 have their respective dimples. The sheet 40, which is at the bottom of the stack and has no further sheet below it, has no dimples. The sheet 40 could have dimples if desired, but they are not necessary. Also as seen in FIG. 4 and other figures, it is preferred that the locations of the dimples be laterally staggered so that a dimple in one layer does not overlie a dimple in the adjacent layer, both to maintain the spacings of the layers and to avoid a high-heat-flow area at superimposed dimples.

As best seen in FIGS. 2 and 4, the dimples in the adjacent sheets space the adjacent sheets apart by the height of the dimples. The sheets therefore form a regular array that is highly effective as an insulation. The metallized layers of the sheets reflect heat in the manner discussed earlier. There is conductive heat transfer through the sheets in the direction perpendicular to the plane of the sheets (i.e., the through-thickness direction of the collated stack of sheets) only through the contacting surfaces where the tops of the dimples contact the flat faces of the adjacent sheets. These contacting surfaces are quite small in extent, so that there is little area for heat to flow. The sheets themselves are made largely of a material of low thermal conductivity (the polymer layer of each sheet). There may be some thermal conduction in the space between the sheets in some applications, although in the preferred cryogenic-insulation application the space between the sheets is evacuated so that there is substantially no thermal conduction therethrough.

In order to maintain the shape of the sheets within the collated stack, the sheets are made thicker than has been the case for conventional sheets of insulation used in conventional multi-layer insulation. The present sheets are preferably not less than about 0.002 inch thick, whereas conventional sheets of insulation in multi-layer stacks are about 0.00025 inches thick. The increased thickness of the sheets increases their rigidity, so that they do not sag and contact the adjacent sheets (which leads to other conduction paths) in conditions of loading. The added thickness of the sheets increases their weight by a small but acceptable amount.

The increased rigidity of the sheets, such as the sheets 22, 30, 38, and 40, leads to a reduction in the difficulty of collating the sheets. Instead of being formed of sheets that are only about 0.00025 inch thick and are accordingly very flimsy, the present insulation is formed of sheets that are several mils thick and much more rigid (without being overly rigid). The assembler of the insulation may therefore simply drop individual, easily grasped sheets into a form in the proper order and with the proper orientation. The individual sheets automatically align themselves as additional sheets are added, with the dimples accomplishing the required spacing between the sheets.

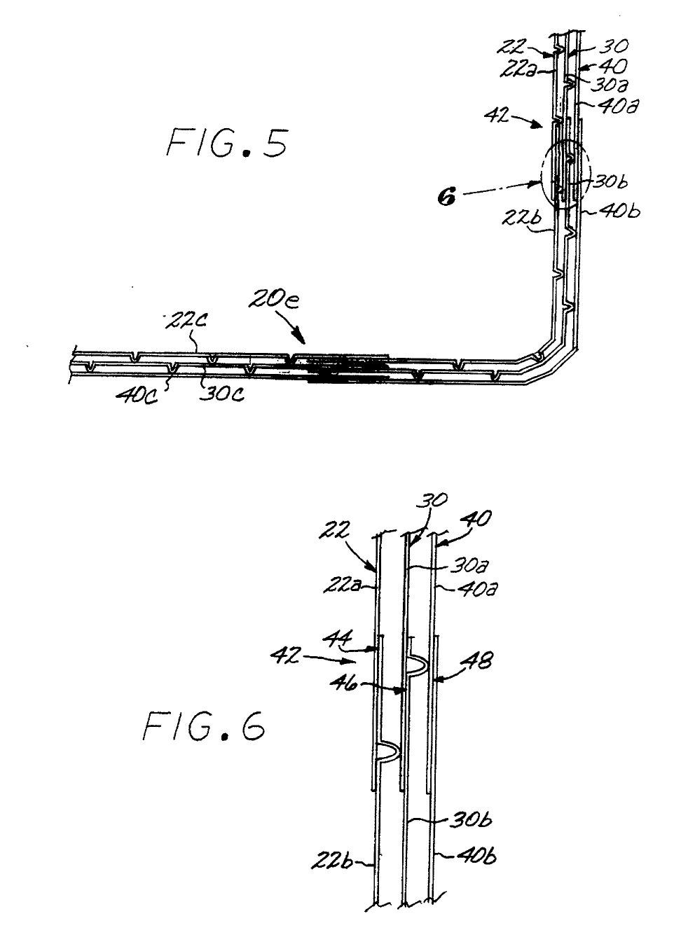

It is often necessary to form joints in the insulation, either because the individual sheets are not sufficiently large in lateral extent or because the joint facilitates the shaping of the insulation to complexly shaped objects. FIG. 5 depicts insulation material 20e having a right-angle therein, and FIG. 6 is a detail of a joint in the insulation material 20e. In this case the joint has three sheets 22, 30, and 40, with the sheets 22 and 30 having dimples and the sheet 40 having no dimples. The sheet 22 has a first piece 22a, a second piece 22b, and a third piece 22c; the sheet 40 has a first piece 40a, a second piece 40b, and a third piece 40c; and the sheet 40 has a first piece 40a, a second piece 40b, and a third piece 40c. The sheets 22a, 30a, and 40a, and the sheets 22c, 30c, and 40c are all substantially flat. The sheets 22b, 30b, and 40b are bent into a right-angle shape to form the right-angle corner in the insulation 20e.

The respective pairs of pieces 22a and 22b, 30a and 30b, and 40a and 40b are joined together at a joint 42, which is shown in greater detail in FIG. 6. The pieces 22a and 22b overlap in a first sheet overlap 44; the pieces 30a and 30b overlap in a second sheet overlap 46; and the pieces 40a and 40b overlap in a third sheet overlap 48. The inventor has determined that very little, if any, radiative energy leaks through such an overlap type of joint. In this joint, it is preferred that at most only one of the overlapped pieces of each pair has a dimple, as illustrated for pieces 22a (no dimple) and 22b (dimple); 30a (no dimple) and 30b (dimple); and 40a (no dimple) and 40b (no dimple). If both members of a pair overlapped at a joint were dimpled, the thickness of the joint would be greater than that of the neighboring regions and would bulge out.

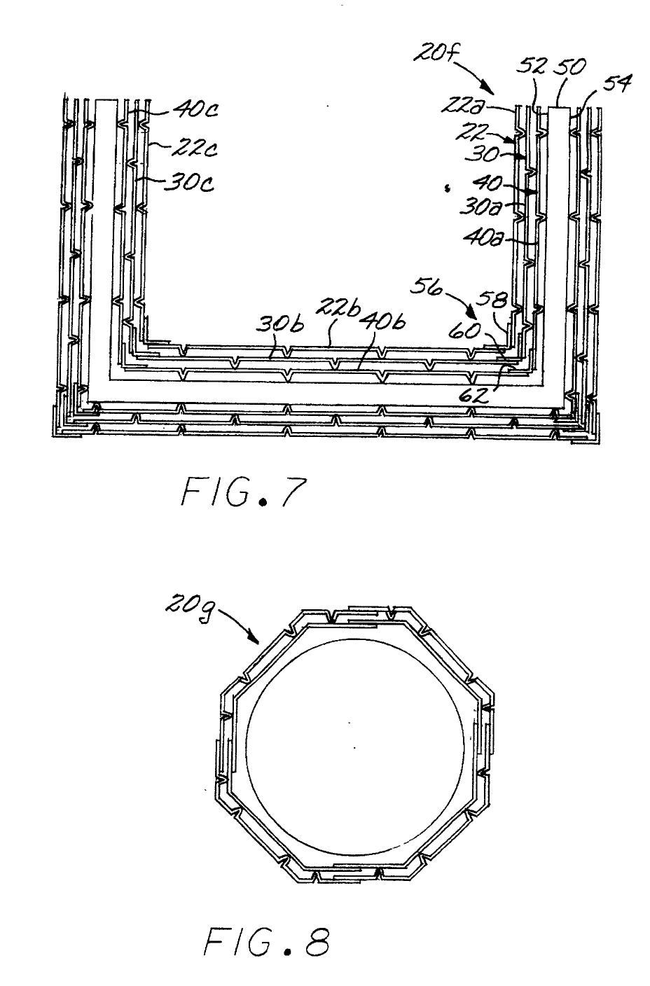

Another technique used in conjunction with the present invention in the forming of shapes and joints is the use of a transition sheet, illustrated in FIG. 7 for insulation material 20f. A complexly shaped object 50 having right-angle corners (such as the bottom of a box) is to be covered on its internal surface 52 and its external surface 54 by multi-layer insulation. Referring to the insulation applied to the internal surface 52, flat insulation sheets 22, 30, and 40 are supplied, as discussed previously. These flat insulation sheets are provided as flat pieces 22a, 22b, and 22c; 30a, 30b, and 30c; and 40a, 40b, and 40c. At an interior corner 56, L-shaped transition sheet 58 overlaps flat piece 22a at one end and flat piece 22b at the other end; L-shaped transition sheet 60 overlaps flat piece 30a at one end and flat piece 30b at the other end; and L-shaped transition sheet 62 overlaps flat piece 40a and one end and flat piece 40b at the other end. The transition sheets 58, 60, and 62 provide effective overlap joints that inhibit radiative and conductive heat transfer therethrough. The transition sheets 58, 60, and 62 are preferably of the same type of construction as the sheets 22 and 30 described earlier, and that description is incorporated here, with the following exception. The transition sheets 58, 60, and 60 typically do not have dimples therein. Instead, the dimpling is provided by the respective flat sheets that are joined by the transition sheets. The transition sheets may have dimpling, but in that case care is taken that there is not dimpling in both sheets that form a joint, to avoid the bulging of the joint as discussed earlier. In the complex shape of FIG. 7, the other interior corner and both exterior corners use a similar approach with transition sheets. As discussed earlier, all of the sheets of insulation that make up the insulation material are structured to permit an easily performed “drop in” assembly.

The present approach may also be used to insulate closed-form complex shapes, such as a cylinder illustrated in FIG. 8. In this case, the insulation material 20g is formed by collation of sheets that are divided into polygonally shaped pieces, each of which spans slightly more than 90 degrees around the perimeter of the cylinder to account for the overlap of the four joints. Only a single geometric shape of the insulation sheets is required. These shapes of the sheets may be formed with the appropriate tooling, and then dropped into place around the perimeter of the cylinder. This fabrication approach for the insulation is much easier than the layup of many individual, very thin sheets by the conventional approach.

The present invention thus provides a sheet insulation material that may be used to insulate both simple and complex shapes, in an economical, efficient manufacturing operation. Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An insulation material, comprising:
a first sheet comprising
a first polymer layer made of a first polymer material, and
a first metallization layer made of a first metallic material overlying and contacting the first polymer layer,
wherein a first selected pattern of a first plurality of first dimples is formed in the first sheet and extends above the first sheet.

2. The insulation material of claim 1, wherein the first sheet has a thickness of not less than about 0.002 inch.

3. The insulation material of claim 1, wherein the first sheet has a thickness of from about 0.002 inch to about 0.010 inch.

4. The insulation material of claim 1, wherein the first polymer material is selected from the group consisting of a polyimide and a polyester.

5. The insulation material of claim 1, wherein the first metallic material is aluminum.

6. The insulation material of claim 1, wherein the first dimples are substantially hemispherical in shape.

7. The insulation material of claim 1, wherein the first dimples have a height above a centerline of the first sheet of from about 0.020 inch to about 0.080 inch.

8. The insulation material of claim 1, wherein the insulation material further includes
a second sheet comprising
a second polymer layer made of a second polymer material, and
a second metallization layer made of a metallic material overlying and contacting the second polymer layer,
wherein a second selected pattern of a second plurality of second dimples is formed in the second sheet and extends above the second sheet, and
wherein the second sheet is positioned adjacent to and facing the first sheet such that the first dimples contact the second sheet and space the second sheet apart from the first sheet.

9. The insulation material of claim 8, wherein the first sheet and the second sheet are of the same material.

10. The insulation material of claim 8, wherein the first sheet is provided as a first piece of the first sheet and a second piece of the first sheet, and the second sheet is provided as a first piece of the second sheet and a second piece of the second sheet, and wherein the insulation material comprises
a joint
whereat the first piece of the first sheet and the second piece of the first sheet overlap each other in a first sheet overlap, and
whereat the first piece of the second sheet and the second piece of the second sheet overlap each other in a second sheet overlap.

11. The insulation material of claim 10, wherein
only one of the first piece of the first sheet and the second piece of the first sheet has dimples in the first sheet overlap, and wherein
only one of the first piece of the second sheet and the second piece of the second sheet has dimples in the second sheet overlap.

12. The insulation material of claim 8, wherein the first sheet is provided as a first piece of the first sheet and a second piece of the first sheet, and the second sheet is provided as a first piece of the second sheet and a second piece of the second sheet, and further including a first undimpled transition sheet and a second undimpled transition sheet, wherein the insulation material comprises
a joint
whereat the first piece of the first sheet overlaps a first end of the first undimpled transition sheet and the second piece of the first sheet overlaps a second end of the first undimpled transition sheet, and
whereat the first piece of the second sheet overlaps a first end of the second undimpled transition sheet and the second piece of the second sheet overlaps a second end of the second undimpled transition sheet.

13. The insulation material of claim 12, wherein the first transition sheet and the second transition sheet are each nonplanar.

14. An insulation material, comprising:
a first sheet having a thickness of not less than about 0.002 inch and comprising
a first polymer layer made of a first polymer material, and
a first metallization layer made of a first metallic material overlying and contacting the first polymer layer,
wherein the first sheet has a thickness of not less than about 0.002 inch, and
wherein a first selected pattern of a first plurality of first dimples is formed in the first sheet and extends above the first sheet; and
a second sheet having a thickness of not less than about 0.002 inch and comprising
a second polymer layer made of a second polymer material, and
a second metallization layer made of a metallic material overlying and contacting the second polymer layer,
wherein a second selected pattern of a second plurality of second dimples is formed in the second sheet and extends above the second sheet, and
wherein the second sheet is positioned adjacent to and facing the first sheet such that the first dimples contact the second sheet and space the second sheet apart from the first sheet.

15. The insulation material of claim 14, wherein the first sheet and the second sheet are of the same material.

16. The insulation material of claim 14, wherein the first sheet is provided as a first piece of the first sheet and a second piece of the first sheet, and the second sheet is provided as a first piece of the second sheet and a second piece of the second sheet, and wherein the insulation material comprises
a joint
whereat the first piece of the first sheet and the second piece of the first sheet overlap each other in a first sheet overlap, and
whereat the first piece of the second sheet and the second piece of the second sheet overlap each other in a second sheet overlap.

17. The insulation material of claim 16, wherein
only one of the first piece of the first sheet and the second piece of the first sheet has dimples in the first sheet overlap, and wherein
only one of the first piece of the second sheet and the second piece of the second sheet has dimples in the second sheet overlap.

18. The insulation material of claim 14, wherein the first sheet is provided as a first piece of the first sheet and a second piece of the first sheet, and the second sheet is provided as a first piece of the second sheet and a second piece of the second sheet, and further including a first undimpled transition sheet and a second undimpled transition sheet, wherein the insulation material comprises
a joint
whereat the first piece of the first sheet overlaps a first end of the first undimpled transition sheet and the second piece of the first sheet overlaps a second end of the first undimpled transition sheet, and
whereat the first piece of the second sheet overlaps a first end of the second undimpled transition sheet and the second piece of the second sheet overlaps a second end of the second undimpled transition sheet.

19. The insulation material of claim 18, wherein the first transition sheet and the second transition sheet are each nonplanar.
